(19) United States
(12) Patent Application Publication
(10) Pub. No.: US 2004/0062600 A1
(43) Pub. Date: Apr. 1, 2004

(54) Friction lock plastic panel connector

(75) Inventor: Steven Jackson, Woodbridge (CA)

Correspondence Address: DENNISON ASSOCIATES, SUITE 301, 133 RICHMOND ST. WEST, TORONTO, ON, M5H 2L7, CA

(73) Assignee: ROYAL ALLIANCE INC.

(21) Appl. No.: 10/638,376

(22) Filed: Aug. 12, 2003

(30) Foreign Application Priority Data
Aug. 12, 2002 (CA) 2,397,822

(51) Int. Cl. F16B 1/00

(52) U.S. Cl. 403/382

(57) ABSTRACT

A plastic panel connector for connecting at least two plastic panels having internal chambers separated by webs in the panels comprises a bar having a plurality of panel engaging posts on at least two side faces of the bar. The panel engaging posts include end posts to opposite ends of the bar and intermediate posts between the end posts. The intermediate posts comprise panel web grip posts and panel web deflection posts. Both the panel web grip posts and the panel web deflection posts have sloped guide surfaces for wedging them into frictionally secured panel engaging positions.

### FIELD OF THE INVENTION

The present invention relates to a panel connector which pushes into and frictionally secures two or more panels together with one another.

### BACKGROUND OF THE INVENTION

A typical method of securing panels together with one another is through the use of connecting brackets which are secured using mechanical fasteners such as screws threaded into the panels.

With the advent of plastic panels, different types of connector means which fit into the end of the panels can be used to secure the panels to one another. However, known plastic panel connectors are not generally strong enough to build an entire plastic shelving system where two, three and even four panels are brought together at a single push-in connector. Furthermore, known push-in panel connectors for plastic panels can often be difficult to properly align with the end of a panel into which the connector is to be inserted.

By way of example, U.S. Pat. No. 5,411,782 which represents the current state of the plastic panel connector art shows a connector bar having a plurality of projecting rectangular lugs which push into and secure two panels in an end to end aligned position with one another. The lugs act as plugs which push into the panel ends. There are large gaps between the lugs to allow them to clear past internal webs of each of the panels. This connector, which is not able to connect more than two panels with one another and which is not able to connect panels at right angles to one another, relies strictly on the plugging action of the lugs and is not able to build an entire plastic shelving system.

U.S. Pat. No. 4,002,261 shows a different plastic panel connector again using plugs to fit into the ends of two panels to be secured to one another. Although the structure in this particular patent is able to secure panels at right angles to one another, it once again is not able to build an entire plastic shelving system.

### SUMMARY OF THE INVENTION

The present invention provides a panel connector for connecting at least two plastic panels having internal chambers separated by webs in the panels. Unlike prior art panel connectors, the panel connector of the present invention is able to build entire plastic shelving systems because of the strong gripping action of the panel connector. Furthermore, this gripping action is provided without sacrificing easy alignment of the panel connector with the ends of the panels into which it is inserted.

More particularly the panel connector of the present invention comprises a bar having a plurality of panel engagement posts on at least two side regions of the bar. The panel engagement posts comprise end posts to opposite ends of the bar and intermediate posts between the end posts. The intermediate posts include panel web grip posts and also include panel web deflection posts. The panel web grip posts and the panel web deflection posts both include cammed or sloped guide surfaces for wedging them into a frictionally secured panel engaging position.

### BRIEF DESCRIPTION OF THE DRAWINGS

The above as well as other advantages and features of the present invention will be described in greater detail according to the preferred embodiments of the present invention in which

FIG. 1 is an exploded perspective view of a pair of panels to be connected at right angles to one another using a panel connector according to a preferred embodiment of the present invention;

FIG. 2 is a side view showing end and intermediate posts of the panel connector of FIG. 1 to be inserted into the end of one of the panels;

FIG. 3 is a perspective view looking down on a set of intermediate posts from the panel connector of FIG. 2;

FIG. 4 is a view similar to FIG. 2 but showing the end and intermediate posts in their panel engaged positions;

FIG. 5 is a side view of a further one of the intermediate posts of the panel connector of FIG. 1 when in its panel engaged position;

FIGS. 6, 7 and 8 are end views of panel connectors according to further preferred embodiments of the present invention;

FIG. 9 is a side view of a shelving system secured using the panel connectors of FIGS. 1 and 6 through 8;

FIG. 10 is a perspective view of a shelving system including further preferred features of the invention; and

FIG. 11 through 14 are enlargements of the features of the shelving system of FIG. 10.

### DETAILED DESCRIPTION ACCORDING TO THE PREFERRED EMBODIMENTS OF THE PRESENT INVENTION

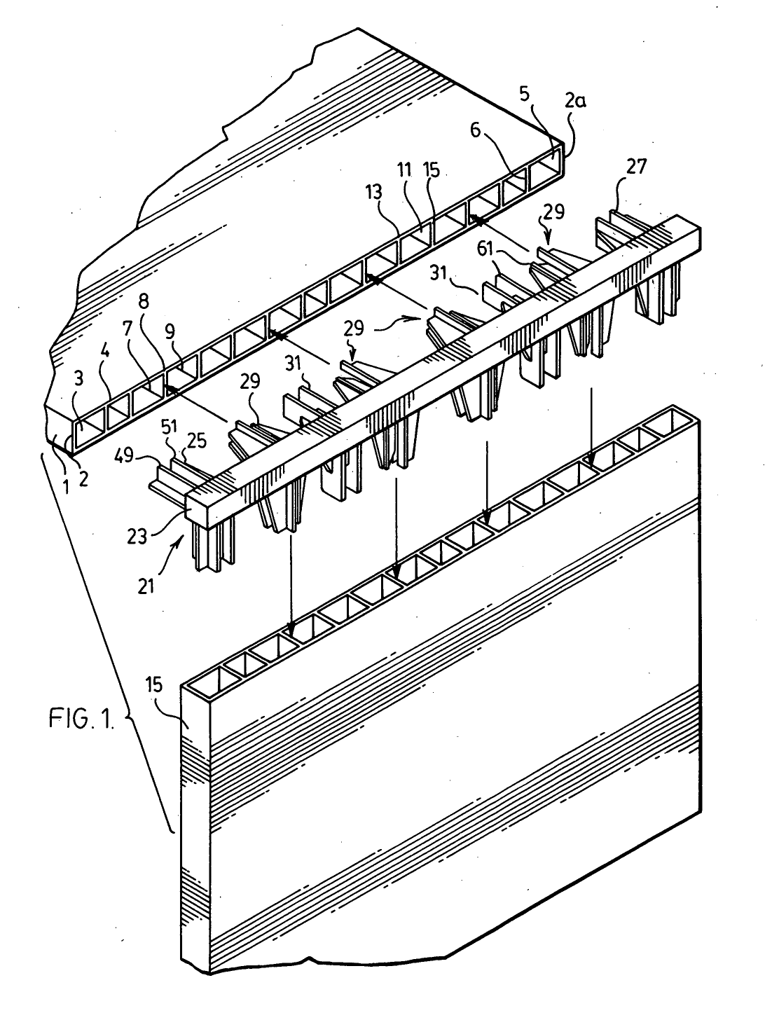

FIG. 1 shows a panel connection system comprising first and second plastic panels 1 and 15 respectively to be secured at right angles to one another by a plastic panel connector generally indicated at 21.

Plastic panel 1 is generally hollow and has a plurality of internal chambers separated by webs within the panel. These chambers include end chambers 3 and 5 to opposite ends of panel 1 and also include intermediate chambers such as chambers 7, 9 and 11. The end chamber 3 is bordered by edge wall 2 and web 4 while the end chamber 5 is bordered by panel edge 2a and web 6.

Panel connector 21 comprises an elongated bar 23 having panel engaging posts on two side faces of the bar at 90 degrees to one another. These posts include end posts 25 and 27 to opposite ends of the bar and a plurality of intermediate posts between the end posts. These intermediate posts take two different forms including posts 29 and posts 31.

It is to be noted that panel 15 has an identical construction to panel 1 and includes the same array of internal chambers and internal webs. Furthermore, the posts projecting from bar 23 at panel 15 in FIG. 1 comprise the same combination of posts as those facing panel 1 and as described immediately above.

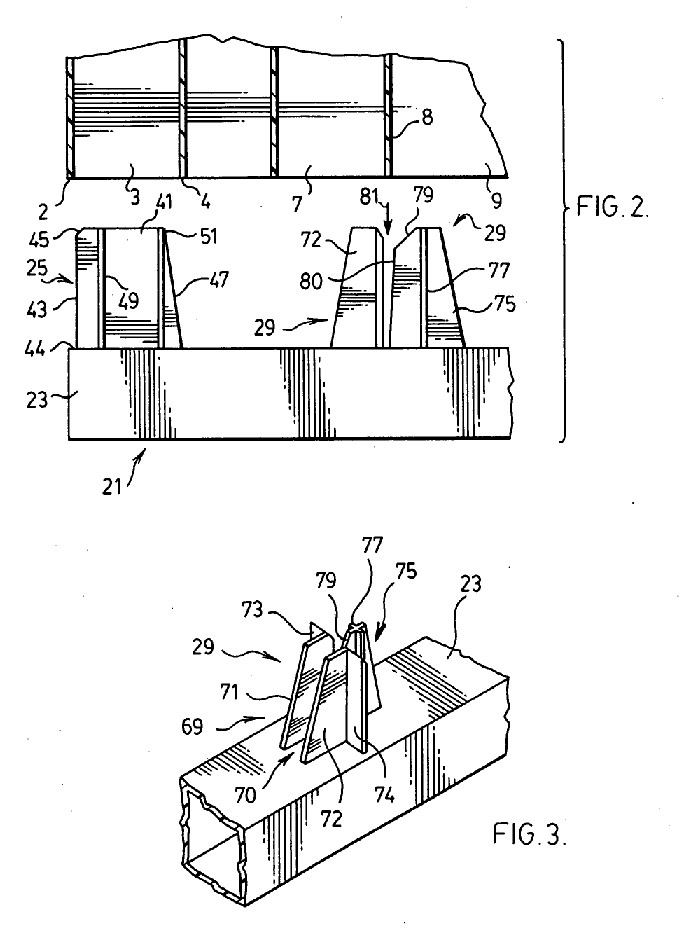

FIGS. 2 through 5 show in greater detail the panel engaging posts and how they fit with the chambers and the webs internally of the panels.

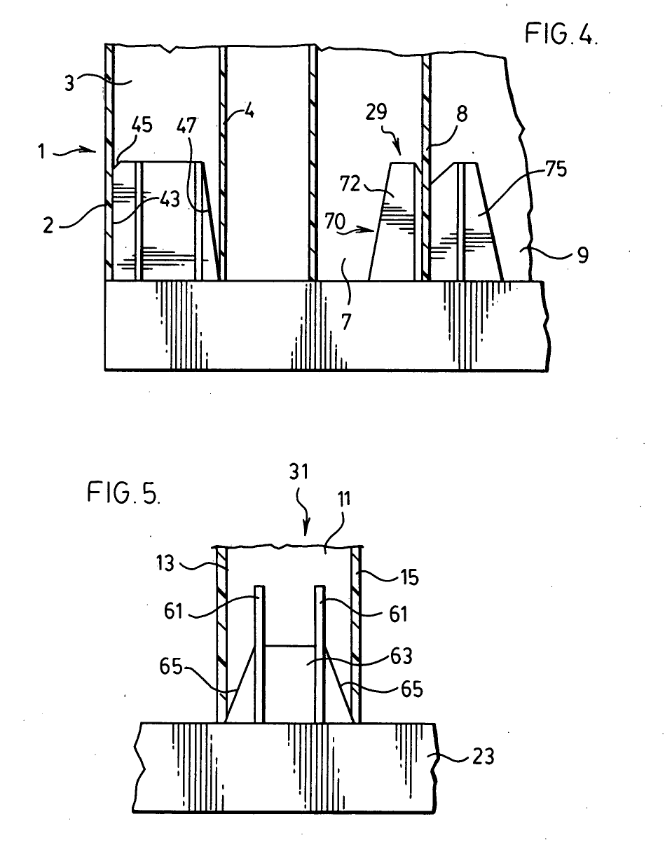

More specifically, end post 25 which has the identical but reversed positioning of end post 27 comprises a main thin flat body portion 41. This body portion has a flat outside edge 43 spaced from the end of bar 23 by a step 44 of the same dimension as the thickness of panel edge 2. Accordingly, when post 25 is pushed into chamber 3, the outside surface of panel edge 2 aligns flushly with the end of bar 23 as shown in FIG. 4 of the drawings.

The main body portion 41 of post 25 further includes a truncated corner 45 above flat edge 43 and a sloped edge 47 to the opposite side of the main body portion from the flat edge. This sloped edge tapers downwardly outwardly towards the base of post 25.

Post 25 further includes a pair of cross ribs 49 and 51 at right angles to the main body portion 41 of the post. These cross ribs, which are better seen in FIG. 1 of the drawings, provide a strengthening of the otherwise thin body portion 41 of the post. The width of the cross ribs is less than the width of chamber 3 so they easily fit into the chamber.

As will be seen in FIG. 4 of the drawings, the end post 25 is inserted into chamber 3 of panel 1 by pushing it into the chamber. The outer or free end of the post has a smaller dimension across its top surface than the base of the post because of the angling of the truncated corner 45 to the one side of the post and the sloped surface 47 to the other side of the post. This top or free end of the post is therefore relatively undersized in comparison to the opening to chamber 3 defined between panel edge 2 and web 4. This provides for an easy alignment guide for fitting the post into chamber 3.

However, as the post is pushed farther into the chamber, the side edges of the post begin to frictionally engage with panel edge 2 and web 4. In particular, sloped edge 47 which is substantially wider at the base of the post wedges against web 4. The wedging action is sufficient to cause a deflection of the web. However, the same is not true to the other side of the post where the flat post edge 43 lines up over most of its length against the panel edge 2. As a result, there is no distorting of the panel edge which is visible at the end of the assembly.

As will be appreciated from the description immediately above, end post 25 acts along its angled edge 47 as a web deflection post pushing against web 4. In order to do this, post 25 completely fills chamber 3.

Post 31, which is best shown in FIG. 5 of the drawings, also acts as a web deflection post. This is the post that inserts completely into chamber 11 bordered by webs 13 and 15.

Post 31 is formed by a pair of ribs 61 standing up from the bar 23 of the connector. As seen in FIG. 1 of the drawings, the width of the ribs is less than the width across chamber 11. As seen in FIG. 5 of the drawings, the spacing between the ribs is substantially less than the length of chamber 11. Accordingly, the ends of the ribs which form the end of post 31 is undersized relative to and easily inserted into chamber 11.

A wall 63 of the plastic material is provided between the two ribs as shown for strengthening of the post. Provided to the outside of the ribs 61 near the base of post 31 are a pair of downwardly outwardly angled wing portions 65. The dimension across post 31 at the base of the two wings 65 is slightly greater than the length of chamber 11. Therefore, when post 31 is fully inserted into the chamber, the wings wedge against and provide a slight deflection of webs 13 and 15. This in turn provides an extremely positive friction fit of post 31 within the chamber even though the post is easily inserted into the chamber.

The fact that there is a slight deflection of both of the webs 13 and 15 is immaterial from an appearance stand point because both of these webs are hidden interiorly of the joint between the connector and the panel.

FIGS. 2 through 4 of the drawings show a different type of post fit between the connector and the panel. In particular, these figures show post 29 which is in fact formed by three separate post members. These post members comprise post members 69, 70 and 75. Post members 69 and 70 are identical in configuration but reversed in position relative to one another. More specially, post member 69 comprises a first leg portion 71 and a second leg portion 73 at right angles to post leg 71. Post 70 comprises a first leg 72 and a second leg 74 at right angles to leg 72.

The two post members 69 and 70 are separated by a space and the post member 75 is positioned on the bar 23 of the connector facing the space between post members 69 and 70. Post member 75 is formed by a main leg upstanding from the connector bar with a small cross rib 77 to support the main leg of post member 75.

The upper end of post member 75 on its side facing the other two post members has a truncated corner 79. This truncated corner provides an angled guide surface to a small slot 81 between the front edge surface 80 of post member 75 and the other two post members 69 and 70.

As can be seen in FIG. 4 of the drawings, post 29 rather than acting as a web deflecting post acts as a web grip post. This occurs because with the insertion of the post 29 into the panel the two post members 69 and 72 fit into but do not completely fill chamber 7 while the post 75 fits into without completely filling the chamber 9 of the panel. The panel web 8 is guided by the truncated guide corner 79 of post member 75 into the slot 81 between the three post members. This slot is, at its outer end, much wider than the web for an easy guided fitting of the web into the slot. However, the width of the slot tapers downwardly inwardly towards the base of the post where the slot is in fact narrower than web 8. Due to the resilient nature of the plastic material in the construction both the web and the post will slightly deform as the web is pushed completely into slot 81 providing an extremely tight friction grip of the post on the web.

It is to be noted that there is a very small area contact surface between the front edge 80 of post member 75 and web 8. This is complemented by the wider surface area contact between the two leg portions 73 and 74 of post members 69 and 70 to the opposite side of web 8. This combination of contact surfaces with the web provides an extremely effective friction lock of the connector with the panel.

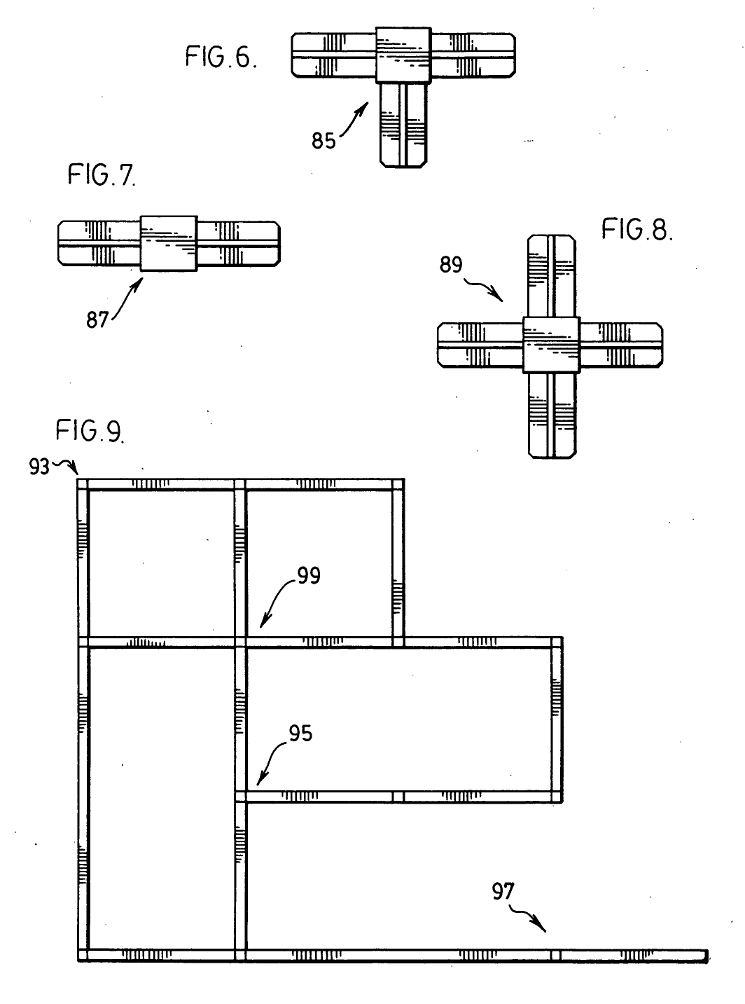

The description above relates to the connection of two plastic panels at right angles to one another. FIGS. 6 through 8 of the drawings show plastic panel connectors which allow different alignments of connected panels.

More specifically, FIG. 6 shows a panel connector generally indicated at 85 comprising a plastic bar supporting connector posts on three different faces of the bar. FIG. 7 shows a connector generally indicated at 87 having panel engaging posts to opposite side faces of the bar. FIG. 8 shown a panel connector generally indicated at 89. This panel connector comprises a support bar with posts extending from all four side faces of the bar.

FIG. 9 of the drawings shows a shelving system generally indicated at 91 which uses all of the panel connectors 21, 85, 87 and 89. For example, panel connector 21 would be used at the outside corner 93 of shelving system 91. Panel connector 85 is used at the connection area generally indicated at 95 of shelving system 91. Panel connector 87 is used at area 97 of shelving system 91 and panel connector 89 is used at area 99 of shelving system 91.

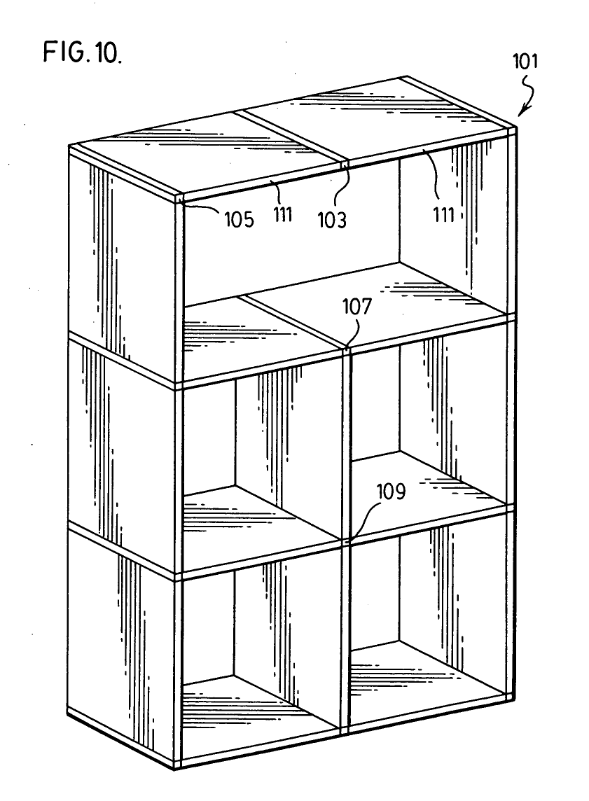

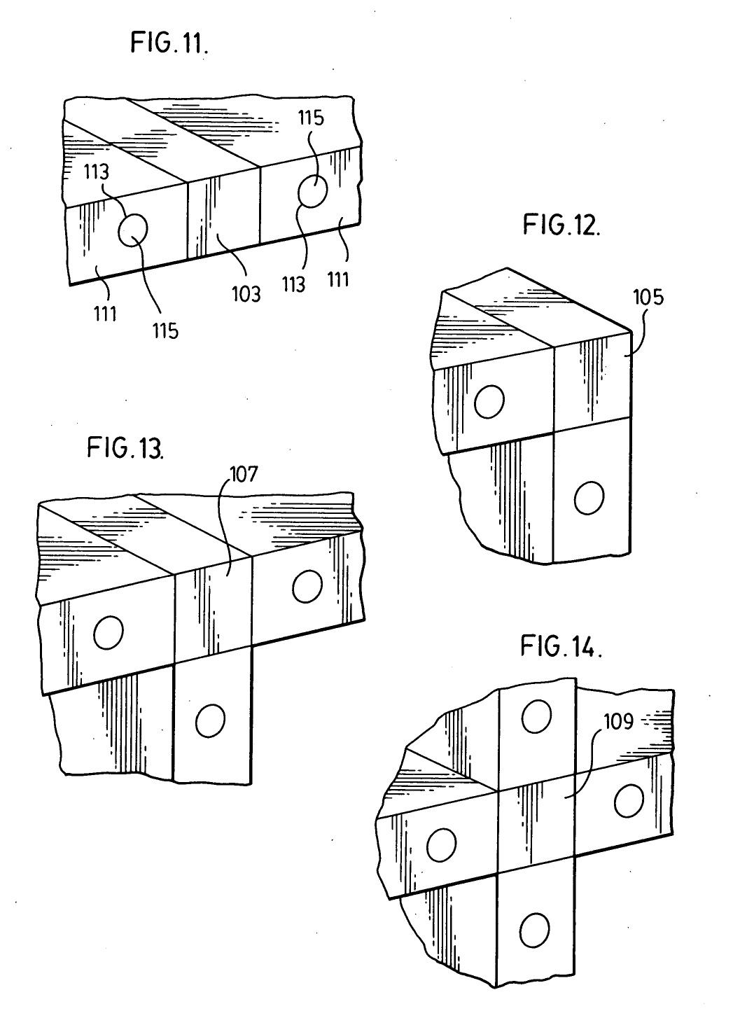

FIG. 10 shows a panel construction system, e.g. shelving system, 101. This shelving system includes a plurality of thermoplastic generally hollow panels such as panels 111. Some of the panels extend horizontally while some of the panels extend vertically. Generally speaking, system 101 is very similar to the system earlier described. However, the one difference is that the end posts of the connector bars 103, 105, 107 and 109 include small projections such as projections 115 on the end posts of bar 103 best shown in FIG. 11. The panels include wall openings such as wall openings 113 of panels 111 also shown in FIG. 11. The projections snap lock into the wall openings to further enhance the interlock between the bars and the panels.

From the description above, it will now be seen how individual plastic panels are easily and positively secured to one another by a plastic panel connector which can easily be used to build an entire plastic shelving system.

Although various preferred embodiments of the invention have been described in detail, it will be appreciated by those skilled in the art that variations may be made without departing from the spirit of the invention or the scope of the appended claims.

The embodiments of the invention in which an exclusive property or privilege is claimed are defined as follows:

1. A plastic panel connector for connecting at least two plastic panels having internal chambers separated by webs in the panels, said panel connector comprising a bar having a plurality of panel engagement posts on at least two side regions of said bar, said panel engagement posts comprising end posts to opposite ends of said bar and intermediate posts between said end posts, said intermediate posts including panel web grip posts and also including panel web deflection posts, said panel web grip posts and said panel web deflection posts presenting sloped guide surfaces for wedging said panel grip posts and said panel web deflection posits into frictionally secured panel engaging positions.

2. A panel connector as claimed in claim 1 wherein said panel web grip posts comprise first, second and third post members, said first and second post members being separated by a gap, said third post member having a post edge facing said gap between said first and second post members.

3. A panel connector as claimed in claim 2 wherein said third post member has a truncated corner above said edge thereof.

4. A panel connector as claimed in claim 2 wherein said first and second post members are each L-shaped presenting flat leg surfaces to opposite sides of said gap between said first and second post members.

5. A panel connector as claimed in claim 1 wherein said panel web deflection posts include a wedge shaped base post to each side of each panel web deflection post.

6. A panel connector as claimed in claim 1 wherein each end post has a flat outside edge and a wedge shaped inside edge facing said intermediate posts.

7. A panel connection system comprising first and second plastic panels each having internal chambers separated by webs in the panels and a plastic panel connector, said plastic panel connector comprising a bar having a plurality of panel engagement posts on separate side faces of said bar, said panel engagement posts including end posts to opposite ends of the bar and intermediate posts between said end posts, said intermediate posts including posts which act as panel web grip posts and posts which act as panel web deflection posts such that said panel connector provides two different gripping actions on the panels, said panel web grip posts and said panel web deflection posts presenting sloped guide surfaces for wedging into frictionally secured panel engaging positions in the plastic panels.

8. A panel connection system as claimed in claim 8 including a third plastic panel having internal chambers separated by webs within the third plastic panel which is to be connected to said first and second panels by said plastic panel connector.

9. A panel connector system as claimed in claim 8 including a fourth plastic panel having internal chambers separated by webs within the fourth plastic panel which is to be connected to the first, second and third plastic panels by the plastic panel connector.
